(19) United States
(12) Patent Application Publication
(10) Pub. No.: US 2009/0022650 A1
(43) Pub. Date: Jan. 22, 2009

(54) CARBON NANO-TUBE HAVING ELECTRONS INJECTED USING REDUCING AGENT, METHOD FOR MANUFACTURING THE SAME AND ELECTRICAL DEVICE USING THE SAME

(75) Inventors: Seong Jae CHOI, Seoul (KR); Jaeyoung CHOI, Suwon-si (KR); Hyeon Jin SHIN, Suwon-si (KR); Seonmi YOON, Yongin-si (KR); Young Hee LEE, Suwon-si (KR); Ki Kang KIM, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/117,140

(22) Filed: May 8, 2008

(30) Foreign Application Priority Data
Jul. 20, 2007 (KR) 10-2007-0072673

(51) Int. Cl. C01B 31/02

(52) U.S. Cl. 423/445 B; 977/742

(57) ABSTRACT

Disclosed herein are methods for manufacturing a carbon nanotube (CNT) having electrons that are injected, with treatment with a reducing agent, a CNT manufactured according to the method, and an electric device comprising the CNT a CNT manufactured according to the method. The electronic characteristics such as the doped level and the band gap of the CNT having electrons injected therein can be widely and easily adjusted by changing the treatment conditions of the reducing agent.

This application claims priority to Korean Patent Application No. 10-2007-0072673, filed on Jul. 20, 2007, and all the benefits accruing therefrom under U.S.C. §119, the contents of which in its entirety are incorporated hereby by reference.

### BACKGROUND OF THE INVENTION

1. Field of the Invention

The present invention relates to a carbon nano-tube (CNT) having electrons injected therein using a reducing agent and a method for manufacturing the same. In addition, the invention relates to an electrical device comprising the CNT having electrons injected therein.

2. Description of the Prior Art

Current display technology is directed to developing larger display screen and to develop display screens having a high performance. In order to implement a display device with these characteristics, a transparent electrode allowing a current to conduct has been required. Indium tin oxide (ITO) is currently the most commonly used material for the transparent electrode. However, the ITO is high-priced and is easily fractured due to its low strain rate. In addition, the resistance of a device is increased due to cracks occurring when the ITO electrode is bent.

In order to address these problems, carbon nanotube (CNT) have been suggested as a material for replacing the ITO transparent electrode. The reason CNTs have been suggested is that CNTs have excellent electric conductivity, strength and flexibility. In addition, the CNTs can exhibit a metallic or a semiconducting property by simply changing a tube diameter of nanometers. Thus, the electrical characteristics of CNTs can be adjusted by changing the physical shape thereof A flexible transparent electrode using the CNT can be widely applied, as an electrode material for energy devices such as solar cells and secondary cells, as well as, display devices such as LCD, OLED and e-paper. Further, the CNT has been identified as a potential candidate capable of replacing the conventional silicone based devices.

Although CNTs have been spotlighted due to their excellent physical properties, most of the current CNTs have an electrical property limited to a p-type semiconductor. Basically, a CNT is an ambipolar material that can exhibit p-type and n-type conducting properties. However, during the manufacturing processes, such as, for example, arc discharge method, laser vaporization method or vapor deposition method, an acid treatment is carried out in a refinement process in order to remove the metal catalyst used during the process. At this time, a whole doping occurs in the CNT, so that the p-type CNT prevails in the final CNT product.

In order to apply the CNT to a wider variety of fields, there is a need to develop a method capable of freely manufacturing both p-type and n-type CNTs. Accordingly, several methods have been suggested to extend the electrical properties of the CNTs to the n-type semiconductor. For example, several methods have been suggested in which the CNT is doped with a material capable of donating an electron, resulting in a change the CNT's electrical properties. However, in prior art methods of doping CNTs, the doping material remains and acts as an impurity that deteriorates the inherent characteristics of the CNT.

In addition, it would be advantageous to include the process of introducing the n-type doping material to the process of manufacturing the CNT. However, CNT manufacturing methods have proven difficult to change. Furthermore, prior art n-type CNT manufacturing methods do not coincide well with the established device manufacturing technology, such as, technology used in the semiconductor manufacturing process. Specifically, applying the n-type CNT manufacturing method to established device manufacturing technology has proven difficult due to, for example, the size and physical properties of the n-type doping material to be introduced, and the physical shape of the CNT prior to introducing the n-type doping material. Thus, the doping process may adversely modify the electronic structure of the CNT.

### SUMMARY OF THE INVENTION

The present invention provides a method to treat a carbon nanotube with a reducing agent to inject an electron into p-type doped CNTs, thereby providing a CNT having enriched electron density. In addition, invention also provides a method of adjusting an electron density of the CNT to a desired level comprising treating CNTs with reducing agent, a CNT manufactured using the method and an electrical device using the CNT.

Disclosed is a CNT having electrons injected therein, wherein the CNT is produced through a reducing agent treatment and a wherein the CNT having electrons injected therein exhibits a S₁₁/S₂₂ absorbance ratio is greater than or equal to 0.5.

The CNT having electrons injected is a p-type doped CNT, a neutrally doped CNT, a n-type doped CNT, or a mixture thereof The reducing agent may be a borohydride compound, a metal hydride, an organic reducing solvent or hydrogen gas. The borohydride compound may be sodium borohydride, tetrabutylammonium borohydride, or sodium trimethoxyborohydride, the metal hydride may is sodium hydride, diisobutylaluminum hydride or aluminum hydride, and the organic reducing solvent may be hydrazine (N2H4), glycol or diol-based solvent.

Disclosed is a method of manufacturing a CNT composition having electrons injected. The method comprises the steps of: (a) reacting a carbon nano-tube with a reducing agent to produce a CNT having electrons injected therein and a S₁₁/S₂₂ absorbance ratio of 0.5 or more; and (b) separating the CNT having electrons injected therein and a S₁₁/S₂₂ absorbance ratio of 0.5 or more from the reaction mixture produced the (a) step. By adjusting a reduction reaction condition of the (a) step, the CNT composition having electrons injected can be selectively manufactured into a p-type doped CNT, a neutrally doped CNT, a n-type doped CNT or a mixture thereof

In one embodiment, the invention provides a carbon nanotube (CNT) having electrons injected therein, wherein the electrons are injected through a reducing agent treatment.

In another embodiment, the invention provides CNTs having electrons injected therein, wherein the electrons are injected through a reducing agent treatment, wherein the CNT having electrons injected therein exhibits a S₁₁/S₂₂ absorbance ratio of greater than or equal to about 0.5, when spectrum-analyzing the CNT.

In another embodiment, the invention provides a method of injecting electrons into a CNT, the method comprising reacting a CNT with a reducing agent to form a CNT having electrons injected therein, and separating the CNT having electrons injected therein from the reaction product.

In another embodiment, the invention provides a method of injecting electrons into a CNT, the method comprising reacting a CNT with a reducing agent to form a CNT having electrons injected therein, and separating the CNT having electrons injected therein from the reaction product, wherein the CNT having electrons injected therein exhibits a S11/S22 absorbance ratio of greater than or equal to about 0.5 when spectrum-analyzing the CNT.

Further, the invention provides a CNT thin film, a CNT electrode, and a transistor each comprising the CNT having electrons injected therein.

### BRIEF DESCRIPTION OF THE DRAWINGS

The above and other objects, features and advantages of the disclosed embodiments will be more apparent from the following detailed description taken in conjunction with the accompanying drawings in which:

FIG. 1 is a diagram demonstrating the electronic energy level of a carbon nanotubes, illustrating a change of an energy level in refinement;

FIG. 2 is a diagram demonstrating a principle of securing a CNT in which electrons are injected in various levels by a reducing agent treatment;

FIGS. 3A and 3B are graphs demonstrating a correlation between density of states and an electronic energy level in a carbon nanotube (FIG. 3A) that is not doped and a carbon nanotube (FIG. 3B) that is doped in a p-type, respectively;

FIG. 4 is a graph demonstrating optical electron transitions that occur in electronic energy levels of p-type doped metallic and semiconducting nano-tubes;

FIG. 5 is a graph demonstrating an optical spectrum of a CNT that is treated with a reducing agent;

FIG. 6 is a graph demonstrating optical spectrums of CNTs that are secured while using a dispersing agent different from that used FIG. 5;

FIG. 7 is a graph demonstrating a Raman spectrum of a CNT that is treated with a reducing agent;

FIG. 8 is a graph demonstrating Raman spectrums of CNTs that are reduced with the same reducing agent having different concentrations, which shows G band including a BWF signal in a wave number range of 1500˜1600 cm⁻¹; and

FIG. 9 is a graph demonstrating optical spectrums of CNTs that are prepared while using different dispersing agents under same reducing agent treatment condition.

### DETAILED DESCRIPTION OF THE EMBODIMENTS

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the description, details of well-known features and techniques may be omitted to avoid unnecessarily obscuring the presented embodiments of the invention.

In one embodiment, the invention provides a carbon nanotube injected with electrons to a desired level, wherein the electrons are injected using a reducing agent, providing a CNT having electronic properties of a wide spectrum from a p-type to a n-type via the neutral type. According to one embodiment a carbon nanotube that is doped in a p-type during the refinement process is treated with a reducing agent to provide a CNT having electrons injected. In addition, the CNTs treated using a reducing agent is not limited to the p-type doped CNTs. Rather, according to another embodiment, neutral CNT and n-type doped CNT can be treated using a reducing agent to inject the CNT with electrons. Therefore, according to an embodiment of the invention, it is possible to manufacture the CNT into which the electrons are injected to a desired level using the reducing agent, i.e., the CNT are treated such that the CNT has electronic properties of a wide spectrum from a p-type to a n-type via the neutral type.

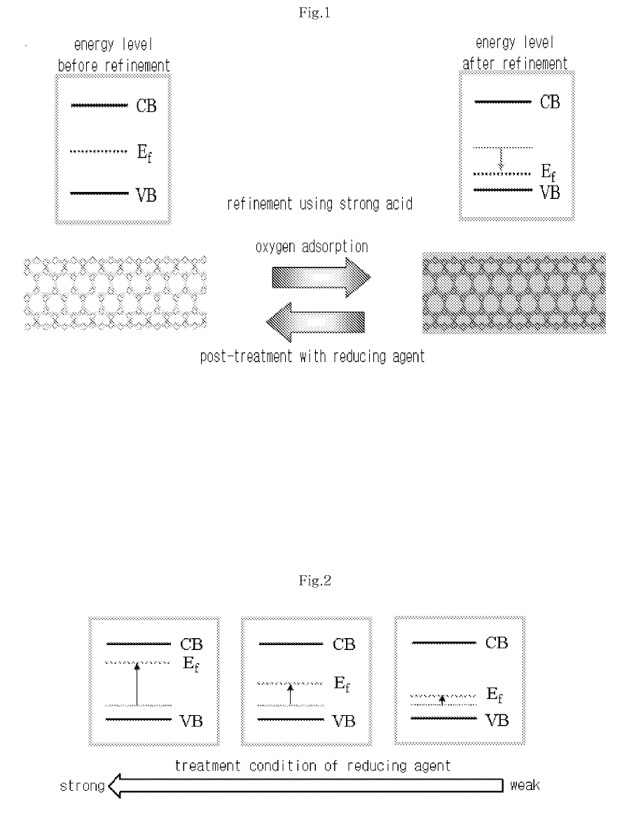

It is known that the electrical properties of the CNT can vary significantly depending on the diameter of CNT and the chirality of a hexagonal carbon ring lattice extending along a major axis of the CNT. Meanwhile, the electronic properties of the CNT can be changed or adjusted by introducing a doping material to the CNT. In this case, the gap between valence bands or conduction bands is different depending on whether the doping material increases or decreases the electron density of the CNT. In particular, during a conventional CNT manufacturing process, the CNT is exposed to an oxidizing agent, such as, for example, oxygen in the air or a strong acid. For conventional methods, in order to increase the purity of the CNTs, the CNTs are treated with an oxidizing agent or strong acid so as to remove the catalyst. Accordingly, using conventional methods, the CNTs produced typically have a p-type semiconductor property, such that the band gap of the CNT becomes wider than the original band gap, as shown in FIG. 1. Due to this phenomenon, although the pure CNT itself has an ambipolarity, it is difficult to sufficiently utilize the ambipolarity of the CNT.

FIG. 1 is a schematic diagram demonstrating an effect of a conventional refinement process using a strong acid on the electronic energy level of the CNT. The left panel of FIG. 1 shows an electronic energy level of the CNT before the refinement (i.e., before the CNT is doped with a p-type doping material). The right panel of FIG. 1 shows an electronic energy level of the CNT, which is modified during the refinement process (i.e., after the CNT is doped with a p-type doping material). During the refinement process of the CNT using the strong acid, the electron density in the valence band (VB) is decreased, so that the p-type doping occurs in the refinement process of the CNT, as shown in FIG. 1. Therefore, the band gap between the valence band (VB) of the CNT and the conduction band (CB) becomes wider, as compared to a case where the CNT has not been refined. As demonstrated in the right panel of FIG. 1, the Fermi level (E_{f}) is shifted to the valence band after refinement. The change in the energy level gap occurs in the doping of the CNT with the p-type doping material, as well as, the refinement of the CNT.

According to one embodiment of the invention, the p-type doping material, which often results due to the refinement process of the CNT, is removed with the electrons provided from the reducing agent, or enough electrons injected to offset the effect of the p-type doping material, thereby changing the electronic characteristics of the CNT. When the CNT treated with the reducing agent is a p-type doped CNT, it is possible to decrease the p-type doping characteristics through the reducing agent treatment and to provide a n-type characteristic depending on the treatment conditions. The reducing agent treatment for the p-type CNT will be referred to as “dedoping.” As described below, through the “dedoping” process, it is possible to selectively reduce the CNT, in which the n-type doping material is directly chemically introduced into the grapheme backbone of the p-type CNT and the p-type doping material that has been already injected, rather than the grapheme backbone of CNT, thereby manufacturing a CNT in which the content of the p-type doping material is decreased. The CNT in which the electrons by the reducing agent treatment are filled in the valence band without exhibiting the p-type or n-type characteristics will be referred to as “neutrally doped CNT.”

In addition to using p-type CNTs, the reducing agent treatment can be performed using neutral CNTs or n-type CNTs, so that it is possible to obtain a variety of CNTs in which the electron density is variably increased to desired levels, as shown in FIG. 2. FIG. 2 provides three panels demonstrating the electronic energy level of CNTs, in which the electrons are injected to various levels, depending on the intensity of the treatment conditions of reducing agent (for example, amount of the reducing agent, treatment time, and the like) produced. By controlling the treatment conditions of reducing agent (for example, amount of the reducing agent, treatment time and the like) CNTs having a wide range of electronic properties can be manufactured. As shown in FIG. 2, the electronic energy level of each CNT produced varies depending on the electron injection level. For FIG. 2, the strength of the treatment conditions of the reducing agent increases from right to left, such that the CNT represented in the left panel is injected with the more electrons then the CNT represented in the right panel. In FIG. 2, the left panel demonstrates that the stronger the treatment conditions of the reducing agent, results in a decrease in the band gap between the valence band and the conduction band (i.e., the gap between E_{f} and CB is decreased). To the contrary, the right panel of FIG. 2 demonstrates weaker treatment conditions of the reducing agent (for example, less reducing agent is used, or the reduction occurs in the shorter time or lower temperature) result in the CNT having a relatively larger band gap.

Therefore, according to an embodiment of the invention, by adjusting the reducing conditions, it is possible to easily adjust the electron injection level of the CNT and to secure a CNT in which the electrical properties such as band gap is adjusted to a desired level. In other words, by changing the treatment conditions of the reducing agent, it is possible to selectively manufacture a CNT having varying levels of electrons injected therein, demonstrating a desired electronic property, among dedoped p-type CNTs, neutrally doped CNTs and n-type doped CNTs.

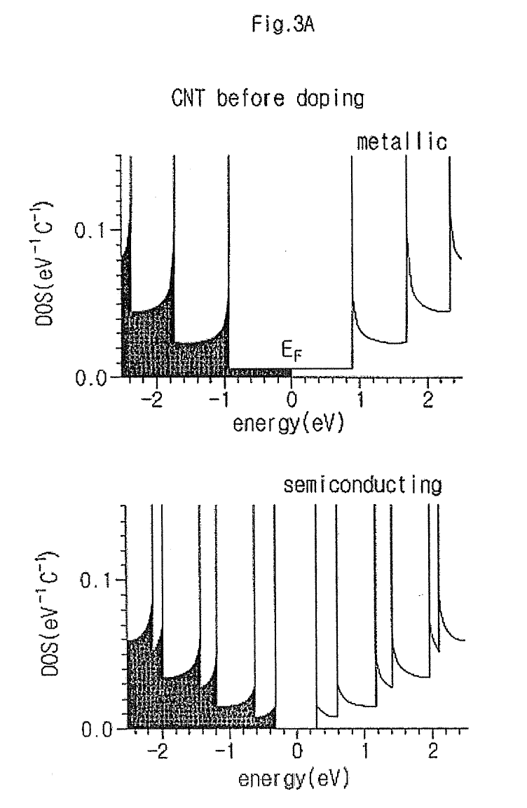

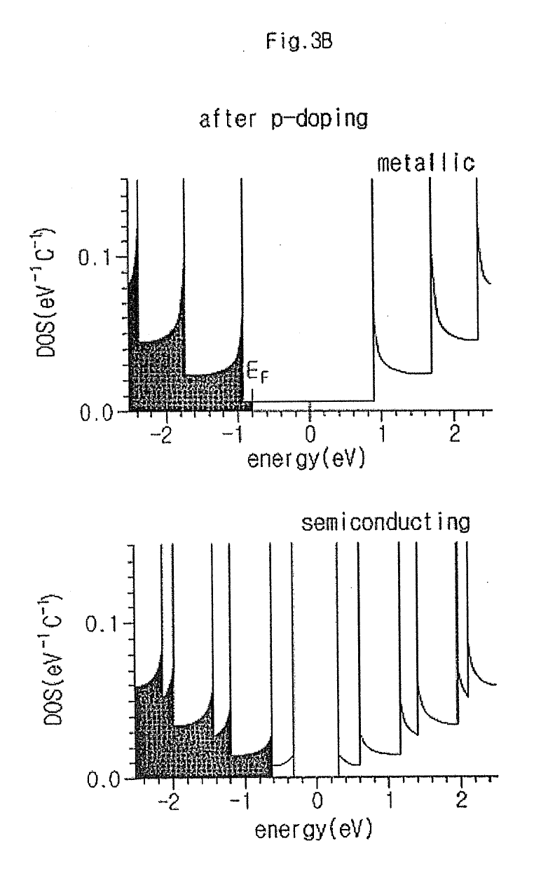

The density of states (DOS) equation can be used to express whether the electrons are filled to which energy level of the electronic levels permitted in the doped CNT. FIGS. 3A and 3B are graphs showing a correlation between density of states and an electronic energy level in a non-doped carbon nanotube (FIG. 3A) and a p-type doped carbon nanotube (FIG. 3B), respectively. FIGS. 3A and 3B also show a relation between density of states and an electronic energy for metallic and semiconducting CNTs. The sharp peaks in FIGS. 3A and 3B indicate areas in which the density of states is rapidly increased and are referred to as a van Hove singularity. The shaded areas in FIGS. 3A and 3B means that the energy level is filled with the electrons. In FIGS. 3A and 3B, on the basis of the 0 (zero) point of an energy axis (horizontal axis), the left side represents a valence band and the right side represents a conduction band. In FIG. 3A, it can be seen that both the metallic and semiconducting CNTs before doping are filled with the electrons to the level having the energy of zero point. When the CNT is p-type doped, the electron density is decreased, as shown in FIG. 3B. Therefore, the position of E_{f} is also moved to the lower energy, as compared to FIG. 3A.

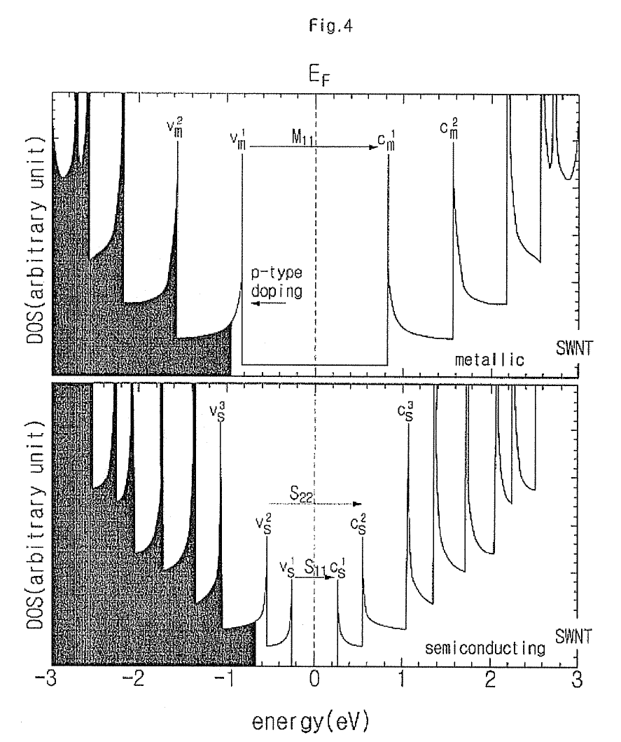

The nanotube absorbs the light in the visible or ultraviolet range and is thus excited. At this time, the electrons in the valence band can transition to the conduction band. In view of the mirror symmetry with respect to the energy of zero point, each of the van Hove singularities of the conduction band and the valence band can be numbered. When determining an electronic characteristic of the CNT, the van Hove singularity of the highest energy in the valence band and the van Hove singularity of the lowest energy in the conduction band are of importance. FIG. 4 shows the numbered van Hove singularities for a single walled nanotube (SWNT).

In FIG. 4, each of the van Hove singularities in the metallic SWNT and semiconducting SWNT are designated with a symbol. That is, c indicates the singularity of the conduction band, and v indicates the singularity of the valence band. In FIG. 4, the number becomes larger as it goes farther from the energy of zero point. The subscripts m and s indicate the metallic and semiconducting states, respectively. The transition of the electrons from the valence band to the conduction band can be expressed with a change in the van Hove state, as shown in FIG. 4. That is, for the metallic CNT, it is vₘ¹→cₘ¹, and for the semiconducting CNT, it is vₛ¹→cₛ¹. Here, the transition is denoted by M₁₁ for the metallic CNT and by S₁₁ for the semiconducting CNT. Likewise, vₛ²→cₛ² transition can be considered as S₂₂ in the semiconducting CNT. FIG. 4 shows both S₁₁ and S₂₂. In addition, although the transitions such as S₃₃, S₄₄ and M₂₂ occur, S₁₁, S₂₂ and M₁₁ are observed in UV-Vis-NIR range.

Most of the CNT samples that are obtained by the conventional method for manufacturing the CNT are mixtures in which the metallic and semiconducting CNT are included. Therefore, all the absorption signals of the S₁₁, S₂₂ and M₁₁ are observed in the optical spectrum of the single CNT sample. Herein, it is inappropriate to limit the absolute signal positions of the S₁₁, S₂₂ and M₁₁ in the optical spectrum since the correct energy necessary for each transition can change according to many factors such as the doping materials, the specific CNT manufacturing method, the diameter of the CNT, the chirality, and the like. However, it is possible to decide the relative signal positions of the S₁₁, S₂₂ and M₁₁ in the optical spectrum since the energies necessary for each transition are different with each other. Regarding the relative positions of the three transition signals in the optical spectrum, S₁₁ appears at the longest wavelength position and M₁₁ appears at the shortest wavelength.

Since, for the p-type CNT, the electron density is lower than before the doping at the van Hove singularity having the highest energy in the valence band area, the signal intensity of the S₁₁ transition that is observed after the p-doping is relatively weaker than before the p-doping, or a shift occurs in the wavelength. When the CNT is treated with a reducing agent to increase the electron density, the electron density of vₛ¹ (and vₘ¹) is increased, so that the intensity of the S₁₁ transition (and M₁₁ transition) is higher than before the reducing agent treatment. However, the intensity of the S₂₂ transition is not affected as much as S₁₁ transition by the reducing agent treatment. The reason the intensity of the S₂₂ transition is not affected as much as the S₁₁ transition by the reducing agent treatment is because it is difficult for the p-doping occurring in the treatment of the strong acid to affect the energy level (vₛ² and cₛ²) of the electron related to the S₂₂ transition while the p-doping affects the energy level (vₛ¹ and cₛ¹) of the electron related to the S₁₁ transition relatively in a high degree. Therefore, when the CNT is treated with the reducing agent, the intensity of the S₂₂ transition is also increased, but a degree of the increase is not high as the S₁₁ transition.

Accordingly, through analysis of the optical spectrum after the treatment for the CNT, it is possible to determine whether the electrons are injected to the CNT from the reducing agent. That is, when a ratio of an absorbance at the highest absorption wavelength position of the optical spectrum absorption band corresponding to the S₁₁ transition and an absorbance at the highest absorption wavelength position of the absorption band corresponding to the S₂₂ transition are measured, it is possible to determine whether a depdoing occurred in the CNT, and whether an electron was injected to the CNT. Hereafter, the ratio of an absorbance of the primary semiconducting electron transition S₁₁ to an absorbance of the secondary electron transition S₂₂ in the optical spectrum of the semiconducting CNT is referred to as “S₁₁/S₂₂ absorbance ratio.”

By measuring the S₁₁/S₂₂ absorbance ratio through the optical spectrum of the CNT, the electrical characteristics of the reduced CNT can be analyzed and determined. In the embodiments, a CNT having a desired electrical characteristic can be manufactured, and the electronic characteristics can be determined through the measure of the S₁₁/S₂₂ absorbance ratio.

In the CNT into which the electrons are injected within an appropriate range through the reducing agent treatment, the S₁₁/S₂₂ absorbance ratio is greater than equal to about 0.5. As described previously, according to an embodiment of the invention, the degree of introduction of the n-type doping material or dedoping can be controlled to have various levels. When the S₁₁/S₂₂ ratio of the CNT is less than 0.5, it means that the CNT is doped in a p-type and the density of electrons involved in the S₁₁ transition is thus decreased. Therefore, the CNT having such S₁₁/S₂₂ absorbance ratio of less than 0.5 corresponds to the CNT that is doped in a p-type.

When the electrical characteristic of the CNT is changed due to the reducing agent, the electron density distribution of the CNT is also changed, which thus affects the plasmon. As used herein, a plasmon refers to the collective quantized vibration of the free electron density. The plasmon can interact with the phonon. As used herein, a phonon refers to the quantized vibration of the nano-tube crystal lattice. Since the Raman spectroscopy measures the vibration characteristic of the molecules due to the phonon, the magnitude and position of the individual phonon signal, as measured by Raman spectroscopy, are affected by the interaction with the plasmon. Therefore, the Raman spectroscopy may be an additional means for measuring the change in the electrical characteristic of the CNT due to the reducing agent.

In the Raman spectroscopy of the CNT, a scatter peak in the wave number of 1500˜1600 cm⁻¹ is referred to as a G band. The G band is known as a Raman signal that is produced when the carbon in the CNT tangential stretching-vibrates. Since the shape, absorption signal intensity and wave number of the G band are sensitively dependent on the characteristics of the CNT, such as, for example, the diameter and oxidized state of the CNT, the G bands are indicators of the electronic state of the CNT. For the metallic CNTs, a sideband is observed at the wave number that is slightly lower than the G band. The sideband is referred as a BWF (Breit-Wigner-Fano) peak, which indicates a shape of the peak curve thereof In a sample in which metallic and semiconducting CNTs are mixed, an increase in the signal magnitude (area) of the BWF peak of the Raman spectrum tends to conform to the increase in the electron density of the CNT. The BWF line shape, which is originated from the plasmon continuum as the electron coupling mechanism, is easily affected by the amounts of the electrons near the Fermi level in the DOS. In addition, when an electron is injected in the CNT, the position of G⁺ peak, indicating the maximum scatter intensity in the G band, is often shifted to the lower wave number. Accordingly, the position change of G⁻ peak is also affected by a change in the electron density of the CNT.

According to an embodiment of the invention, any reducing agent can be used as long as the reducing agent can increase the S₁₁/S₂₂ absorbance ratio of the treated CNT to greater than or equal to about 0.5, and can inject the electrons to the CNT to a desired level by changing the reduction treatment condition. Exemplary reducing agents include, for example, borohydride compounds, metal hydrides, organic reducing solvents, hydrogen gas, and the like. The hydrogen gas has an advantage of reducing the CNT through a dry process. The borohydride compound and metal hydride is added, in a very slow rate, to the stable double bond of C═C of the CNT. Borohydride compounds include, for example, sodium borohydride, tetrabutylammonium borohydride, sodium trimethoxyborohydride, and mixtures thereof. However, since the reduction reaction rate of the metal hydride may be rapid for the p-type doping material, it can selectively reduce the p-type doping material. Therefore, when the metal hydride is used as the reducing agent, it can minimize the change in the grapheme backbone of the CNT (for example, reduction of the C═C double bond of the CNT into a CH—CH single bond). Exemplary metal hydrides include, for example, borohydride based metal hydrides, aluminum hydrides, sodium hydride, diisobutylaluminum hydride, lithium aluminum hydride, and mixtures thereof. When the CNT is reduced by the hydrogen gas, the transition metal catalyst is used or a reduction reaction is made at high temperatures.

In one embodiment, suitable organic reducing solvents include, for example, hydrazine (N₂H₄), glycol based solvents, diol based solvents, or the like solvents. Exemplary glycol based solvents include ethyleneglycol, diethyleneglycol, triethyleneglycol, and the like solvents. Exemplary diol based solvents include 1,3-propandiol, 1,3-butandiol, and the like solvents. Since these solvents donate an electron or hydrogen atom to the CNT during the reduction process, they have an advantage of minimizing the change in the grapheme backbone of the CNT.

As described above, the invention provides CNTs is manufactured such that the electrons are injected in the CNT to a desired level by dedoping the CNT that is doped in a p-type during the refinement process, or by introducing the reducing agent to the neutral CNT. In one embodiment, the CNT having electrons injected is dispersed in a desired solvent with an appropriate dispersing agent and then analyzed for the characteristics thereof. The CNT having electrons injected therein dispersed in a desired solvent can be appropriately utilized for a variety of applications. For example, a CNT thin film can be formed by spraying the solution, in which the CNTs having the electrons injected therein are dispersed, on a proper surface and vaporizing the solvent, or by using a filtering method with a vacuum filtering apparatus. At this time, the dispersing solution including the CNTs having the electrons injected therein, which are dispersed in an appropriate solvent, may be a composition for preparing a CNT thin film.

In one embodiment, the invention provides a CNT electrode comprising the CNTs having the electrons injected therein. For example, a CNT electrode is prepared by mixing the CNTs having the electrons injected therein with a bonding agent and then forming the mixture into an electrode having a proper shape. In addition, it is possible to prepare a CNT electrode by depositing the CNTs having the electrons injected therein on a substrate such as metal or silicone oxide.

According to another embodiment, the invention provides a transistor comprising a CNT having electrons injected therein. A representative embodiment is a field effect transistor in which a CNT having electrons injected therein serves as an electron channel between a source area and a drain area.

According to another embodiment, the invention provides a capacitor comprising a CNT having electrons injected therein. The CNT having electrons injected therein can be used as an electrode material of the capacitor.

The CNT having electrons injected therein can be formed into a coil shape which can be used as an inductor material. In order to implement an inductor having a high inductance, a material having a low winding resistance is desired. Regarding this, since the CNT is a material capable of maintaining a lower resistance while having a shorter length and a smaller diameter of the winding, an inductor device comprising CNTs having electrons injected therein has a high utility value.

In one embodiment, the CNTs having electrons injected therein can also be used as a detection device for a sensor. An example of the sensor comprising CNTs having electrons injected therein is a gas sensor. When a gas molecule, particularly a gas such as oxygen having an oxidation ability, reacts with the CNT, the electrical characteristics of the CNT, such as conductivity, are changed. Therefore, using such phenomenon, a small-scaled sensor capable of detecting a small amount of gas can be fabricated. In addition, a FET bio-sensor comprising the CNT having electrons injected therein can also be fabricated. As described above, this FET can be used as a bio-sensor, in which the CNTs having electrons injected therein of the invention serve as an electron channel. The bio-sensor measures a change in the electrical characteristics of the FET, which occurs when the CNT is connected to a bio-molecule such as DNA.

In addition, CNTs having electrons injected therein, can be used to manufacture a field emission device comprising the CNT. The CNTs having electrons injected therein of the invention can be used as a material of a field emission tip of a FED (Field Effect Display) device.

Further, an electrode comprising the electron-injected CNT can serve as a capacitor of a memory device. Using the small size and high stability of the CNT, it can be used to develop a memory device having a smaller size and a more highly integrated capacity.

According to an embodiment of the invention, the CNT that is doped in a p-type during the refinement process can be converted into a CNT that p-type characteristics are decreased or is doped neutrally or in a n-type through the reducing agent treatment. Furthermore, since the treatment conditions of the reducing agent are changed to adjust the injection level of the electrons, it is possible to provide a general method capable of easily adjusting the electrical characteristics of the CNTs to be produced, such as band gap. The CNTs having electrons injected therein can be used for manufacturing an electric device such as flexible transparent electrode.

In another embodiment, the invention provides a method of injecting electrons into a CNT, the method comprising reacting a CNT with a reducing agent to form a CNT having electrons injected therein, and separating the CNT having electrons injected therein from the reaction product, wherein the CNT having electrons injected therein exhibits a S11/S22 absorbance ratio of greater than or equal to about 0.5 when spectrum-analyzing the CNT.

The invention will now be described in further detail with reference to the following examples. The following examples and experiments are for illustrative purposes only and not intended to limit the scope of the claimed invention.

In the examples and experiments, the CNT (provided by Iljin Nanotech Company, ASP-100F) used was prepared by an electric arc discharge method. The diameter of the CNT was about 1˜1.5 nm and the metallic and semiconducting CNTs were mixed. During the refinement, the raw material of the CNT was converted into a CNT that was doped in a p-type.

### Embodiment 1: Reducing Agent Treatment for the CNT

For this example, tetrabutylammonium borohydride (TBAB) ((C₄H₉)₄NBH₄) or lithium aluminum hydride (LiAlH₄), which are reducing agent of metal hydrides, were used as the reducing agent of the CNTs.

In the case of TBAB, 10 mg of CNTs and 3.0 g of TBAB were added to the 30 ml of toluene solvent. The mixture was dispersed and reacted by sonication for 10 hours. After the reduction reaction was completed, the CNTs were washed three times using toluene. Then, the reduced CNTs was recovered by the centrifugal separation.

In the case of LiAlH₄, the reduction reaction was carried out in the same manner as the TBAB, except that a 1 ml solution of LiAlH₄ and THF (tetrahydrofuran)[0.1M LiAlH₄ in the 1 ml solution] was used instead of TBAB 0.3 g. In addition, for some reactions 1 mL solutions respectively having 0.01M and 0.001M LiAlH₄ instead of 0.1M LiAlH₄ were used to carry out the same reduction reaction.

### Embodiment 2: Dispersing of the CNT

Methods of Dispersing CNTs, whether or not the CNTs are reduced, in a desired solvent by using an appropriate dispersing agent are well known. Therefore, details on the CNT dispersion will not be explained here. Hereafter, a method of dispersing the CNT using NaDDBS and PSS will be described.

For this example, 1 mg of CNTs that were reduction-treated, or 1 mg of CNT that were not reduction-treated, and 100 g of sodium polystyrene sulfonate (PSS) were added to 10 ml water. Then, the mixture was dispersed by the sonication of 10 hours. After dispersing, impurities that were not dispersed were removed by the centrifugal separation.

In the case of sodium dodecylbenzenesulfonate SaDDBS), it was dispersed in the same manner as the PSS, except that 10 mg NaDDBS was used instead of 100 mg PSS and the heavy water (D₂O) was used instead of the water.

### Experiment 1: Optical Spectrum of the Reduced CNT

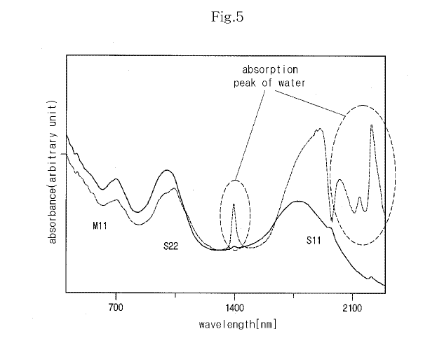

In this experiment, how the electronic energy level of the CNTs changed depending on the reducing agent treatment was determined. CNTs that were reduced using the TBAB, as described in embodiment 1, and the CNTs that were not reduction-treated were respectively dispersed in the heavy water using the NaDDBS dispersing agent, as detailed in embodiment 2. Visible-near infrared spectrum was obtained for the NaDDBS dispersing solutions. The optical spectrum is shown in FIG. 5.

In FIG. 5, the absorption peak within an elliptical dotted line indicates the absorption peak of the water solvent, which is not related to the reduced CNT of the invention. However, in FIG. 5, the peaks indicated with S11, S22 and M11 are absorption peaks that are produced by the primary and secondary transitions of the semiconducting CNTs and the primary transition of the metallic CNTs, respectively. The graph of the solid line in FIG. 5 represents the CNTs that have dispersed in NaDDBS without reducing with TBAB, and the graph of dotted line represents the CNTs that are dispersed in NaDDBS after reducing it with TBAB.

Referring to FIG. 5, the increase in the signal intensity of the peak corresponding to S11 transition for the CNT treated with the reducing agent TBAB is notable when compared with the S11 transition for the CNT before reduction. In case of the CNT treated with the reducing agent, the signal intensity of the S22 absorption peak is similar to or less than the signal intensity before the reduction. The M11 peak is consistently decreased.

When the electrons are injected in the CNT by the reducing agent, the highest van Hove singularity of the valence band is filled with the electrons. Accordingly, the intensity of the S11 transition may be proportional to the reduction extent of the CNT. In FIG. 5, it can be seen that the absorbance at the position (i.e., highest absorption wavelength) exhibiting the highest signal intensity in the peaks due to the S11 transition is less than the absorbance at the highest absorption wavelength due to the S22 transition before the reduction and is increased to a value higher than that absorption after the reducing agent treatment. In FIG. 5, the S11/S22 absorbance ratio is less than 1 before the reducing agent treatment and increased to about 2 after the treatment. Accordingly, it can be seen that the S11/S22 absorbance ratio is considerably increased more than the absorbance of the individual peak of S11 or S22.

From the experiment, the increase of the electron density and the decrease of the band gap were observed. This leads to the conclusion that dedoping of the p-type CNT occurs following the reducing agent treatment. In particular, it was confirmed that the signal increase of the S11 transition was conspicuous when compared to the S22 transition. From this, it can be seen that the S11/S22 absorbance ratio is a parameter that is dependent on whether the CNT is reduced or not. Further, the S11/S22 absorbance ratio demonstrates whether the CNT is reduced or not with increased sensitivity as compared with the signal intensity of the S11 or S22 transition. Thus, determination of the S11/S22 absorbance ratio is an effective means of exhibiting the state of the CNTs.

Experiment 2: S22 Peak Change of the CNT Dispersed with PSS

This experiment was performed using the reducing agent TBAB as in the experiment 1, except that PSS was used as a dispersing agent and the water was used as a solvent. Thus, CNT treated with the reducing agent TBAB and CNT before reducing treatment were dispersed in PSS as described in the optical spectrum of the CNT, the intensity of the spectrum signal may vary depending on the solvent and dispersing agent used. For this experiment, how the intensity of the absorption signal resulting from the S22 transition was changed by the reducing agent treatment in the condition different from the experiment 1 was determined.

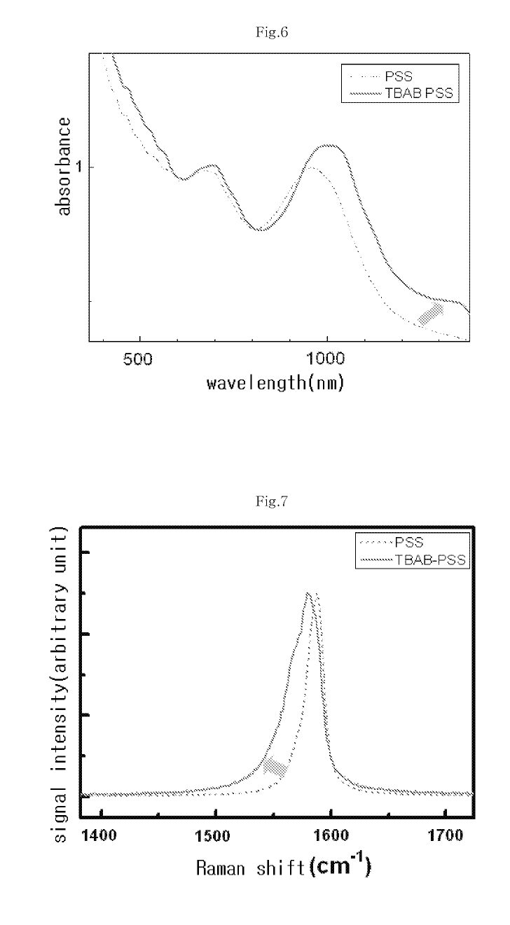

FIG. 6 shows an optical spectrum near the S22 transition of the CNT obtained according to the experimental conditions of the experiment 2. In FIG. 6, the solid line represents the CNTs that are dispersed with PSS after reducing it with TBAB, and the dotted line represents the non-reduced CNTs that are dispersed with PSS. From the spectrum of FIG. 6, it can be seen that the reducing agent treatment TBAB in the experiment conditions of the experiment 2 slightly increases the intensity of the S22 absorption peak of the CNTs and shifts the highest absorption wavelength of the absorption peak to the long wavelength. However, it can be seen that there is no substantial change in the M11 absorption peak.

It can be seen from FIG. 6 that when the proper solvent and dispersing agent are used, information on the electronic characteristics of the CNT can be obtained from the change in the signal intensity of the S22 peak before and after the reducing agent treatment and the wavelength transition data.

### Experiment 3: Reducing Agent Treatment and Observation of Raman G Band

In addition to the optical spectrum, information on the electronic state of the CNT can be obtained using the Raman spectroscopy. In this experiment, a BWF signal was determined near a Raman scatter wave number 1500˜1600 cm⁻¹ for the CNTs manufactured under the conditions outlined in experiment 2.

FIG. 7 shows a Raman scatter spectrum observed in this experiment. In FIG. 7, the solid line (TBAB-PSS) represents the CNTs that have dispersed with PSS after reducing it with TBAB, and the dotted line (PSS) represents the non-reduced CNTs that are dispersed with PSS. In FIG. 7, in case of the CNTs treated with the reducing agent, the area of the BWF signal is larger than the non-reduced CNT (i.e., the signal intensity is increased for CNTs treated with the reducing agent) and the position of G⁺ peak, the wave number representing the maximum intensity is shifted to the lower wave number. This tendency conforms with the increase in the electron density of the CNT resulting from the electrons injected in the CNTs from the reducing agent, as described above, and coincides with the tendencies shown in the experiments 1 and 2.

### Experiment 4: Change in the Characteristics of the CNT Depending on the Concentrations of the Reducing Agent

In this experiment, whether increasing the amount of reducing agent used to treat the CNTs would result in having the electron density increased. In this experiment, different concentrations of the reducing agent LiAlH₄ were used to treat CNTs, as described in embodiment 1. In particular, the CNTs were treated with 0 M, 0.001M, 0.01M and 0.1M LiAlH₄ according to embodiment 1. The reduced and not-reduced CNTs were then dispersed in the toluene. The correlation between the concentrations of the reducing agent and the Raman BWF signal was observed.

FIG. 8 is graph providing the Raman scatter spectrum obtained from analyzing the samples prepared according to the conditions of this experiment. In FIG. 8, the sample labeled “Toluene” represents the CNTs that are dispersed in the toluene without adding the reducing agent, and the others are labeled with the LiAlH₄ concentration used, respectively. In FIG. 8, for the samples treated with the reducing agent, the data indicates that the higher the concentration of LiAlH₄ in the reducing agent treatment, the stronger the intensity of the BWF signal (i.e., the area is increased). In addition to the increase of the signal intensity, the data also demonstrates that the position of G⁺ peak, the wave number, at which the maximum scatter occurs, is shifted to the lower wave number. In FIG. 8, in case of the CNTs treated with 0.1M LiAlH₄, the area of the BWF signal was larger (i.e., signal intensity was increased) than the non-reduced CNT (“toluene” graph) and the position of G⁺ peak, the wave number representing the maximum intensity was shifted to the lower wave number. As can be seen from FIG. 8, although the electron density of the CNTs increased due to the reducing agent treatment, a predetermined amount or more of LiAlH₄ should be used so as to observe the change of the electronic characteristics in the CNT through the Raman BWF peak.

In this experiment, it can be confirmed that the electronic characteristics of the CNT can be controlled by adjusting the amount of the reducing agent treating the CNT or the reduction reaction time.

### Experiment 5: Effects of the Type of the Dispersing Agent on the Reduced CNT

In the manufacturing process of the CNT according to the invention, the CNTs are dispersed in an appropriate solvent using the dispersing agent. In the above experiments, it can be seen that the specific analysis values of the electronic characteristics may be different depending on the type of dispersing agent and solvent in which the CNTs are dispersed. For example, in case of the S22 peak, there is a difference between NaDDBS/heavy water (FIG. 5, experiment 1) and PSS/heavy water (FIG. 6, experiment 2). Therefore, determined whether the dispersing agent could significantly influence the analytical results for the electronic characteristics of the CNT having electrons injected therein. In other words, the inventors determined whether the dispersing agent distorted the analytical results for the electronic characteristics of the CNT having electrons injected therein. The CNTs prepared under same reducing treatment conditions were respectively dispersed using different types of dispersing agents and then their optical spectrums were compared. Specifically, the CNTs were treated with the reducing agent, LiAlH₄, and cetyl trimethyl ammonium bromide (CTAB), Triton X-100 or NaDDBS, which are anionic, neutral non-ionic and cationic surfactants, respectively, were used as the dispersing agent so as to observe the effects of the various dispersing agents.

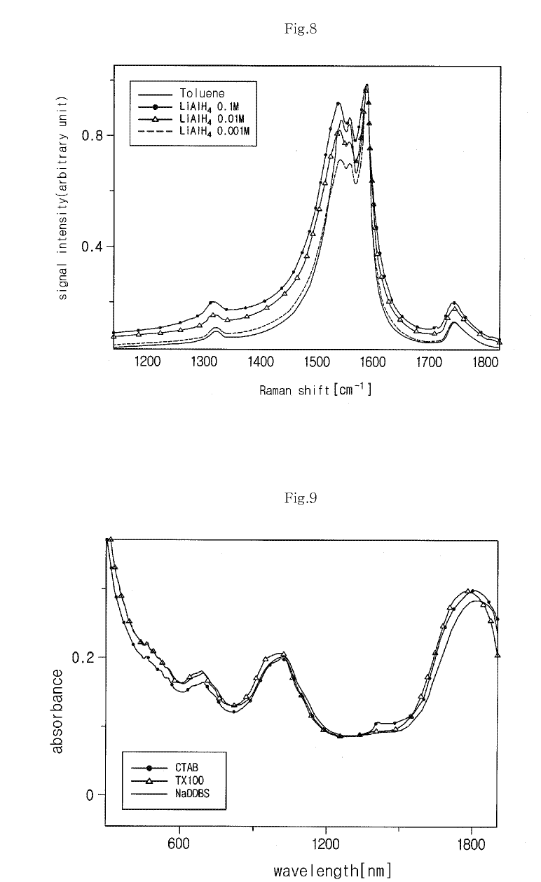

FIG. 9 graph providing the optical spectrums of the CNTs that have been reduced and dispersed according to this experiment. The CNT samples dispersed with CTAB, Triton X-100 and NaDDBS are indicated with CTAB, TX100 and NaDDBS according to the legend in a box of FIG. 9. In FIG. 9, it can be seen that the shapes and signal intensities of the S11, S22 and M11 peaks are almost identical for all the CNT samples prepared using the three types of dispersing agents. That is, the CNTs dispersed with the anionic, neutral ionic and cationic surfactants exhibited the similar optical spectrum curves and the almost identical signal intensities, as long as, the reduction treatment conditions are same. Therefore, it can be concluded that there is no significant change in the S11/S22 absorbance ratio resulting from the use dispersing agents.

From this experiment, it can be seen that the types of the reducing agent and the specific reduction reaction conditions considerably affect the electronic characteristics of the CNT having electrons injected therein. Further, this experiment also demonstrates that the dispersing agent used has little affect on the electronic characteristics of the CNT.

As described above, from the embodiments and the experiments, it can be seen that when the CNT is treated with the reducing agent, the electrons are injected in the CNT and thus the electron density can be increased to a desired level. Using the invention, it is possible to sufficiently and easily utilize the ambipolarity of the CNT, thereby enabling the development of high-performance electronic devices.

While the invention has been shown and described with reference to certain exemplary embodiments thereof, it will be understood by those skilled in the art that various changes in form and details may be made thereto without departing from the spirit and scope of the invention as defined by the appended claims.

In addition, many modifications can be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguished one element from another. Furthermore, the use of the terms a, an, etc. do not denote a limitation of quantity, but rather denote the presence of at least one of the referenced item.

What is claimed is:

1. A carbon nano-tube (CNT) having electrons injected therein, wherein the electrons are injected through a reducing agent treatment.

2. The CNT according to claim 1, wherein the CNT exhibits a S11/S22 absorbance ratio of greater than or equal to about 0.5 when spectrum-analyzing the CNT.

3. The CNT according to claim 1, wherein the CNT is a p-type doped CNT, neutrally doped CNT, n-type doped CNT or a mixture thereof.

4. The CNT according to claim 1, wherein the reducing agent is selected from the group consisting of a borohydride compound, a metal hydride, an organic reducing solvent or hydrogen gas.

5. The CNT according to claim 4, wherein the borohydride compound is selected from the group consisting of sodium borohydride, tetrabutylammonium borohydride, sodium trimethoxyborohydride, or a mixture thereof.

6. The CNT according to claim 4, wherein the metal hydride is selected from the group consisting of sodium hydride, diisobutylaluminum hydride, lithium aluminum hydride, or a mixture thereof.

7. The CNT according to claim 4, wherein the organic reducing solvent is hydrazine (N₂H₄), a glycol based solvent or a diol based solvent.

8. The CNT according to claim 7, wherein the glycol based solvent is ethyleneglycol, diethyleneglycol, triethyleneglycol, or a mixture thereof.

9. The CNT according to claim 7, wherein the diol based solvent is 1,3-propandiol, 1,3-butandiol or a mixture thereof.

10. A method of injecting electrons into a CNT comprising:
(a) reacting a CNT with a reducing agent to form a CNT having electrons injected therein.

11. The method according to claim 10, further comprising: (b) separating the CNT having electrons injected therein from the reaction product.

12. The method according to claim 10, wherein the electron-injected CNT has a S₁₁/S₂₂ absorbance ratio of greater than or equal to about 0.5.

13. The method according to claim 10, wherein the CNT is a p-type doped CNT, neutrally doped CNT, n-type doped CNT or a mixture thereof.

14. The method according to claim 10, wherein the level of electron injection is determined depending on the reaction conditions with the reducing agent.

15. The method according to claim 14, wherein the reaction conditions include types of reducing agent, reaction time and reaction temperature.

16. The method according to claim 10, wherein the reducing agent is a borohydride compound, a metal hydride, an organic reducing solvent or hydrogen gas.

17. The method according to claim 16, wherein the borohydride compound is sodium borohydride, tetrabutylammonium borohydride, sodium trimethoxyborohydride, or a mixture thereof.

18. The method according to claim 16, wherein the metal hydride is sodium hydride, diisobutylaluminum hydride, lithium aluminum hydride or a mixture thereof.

19. The method according to claim 16, wherein the organic reducing solvent is hydrazine (N₂H₄), glycol or diol based solvent.

20. The method according to claim 19, wherein the glycol based solvent is ethyleneglycol, diethyleneglycol, triethyleneglycol, or a mixture thereof.

21. The method according to claim 19, wherein the diol based solvent is 1,3-propandiol, 1,3-butandiol or a mixture thereof.

22. A CNT thin film comprising the CNT having electrons injected according to claim 1.

23. A CNT electrode comprising the CNT having electrons injected according to claim 1.

24. A thin film transistor comprising the CNT having electrons injected according to claim 1.
